(19) United States
(12) Patent Application Publication
(10) Pub. No.: US 2002/0124417 A1
(43) Pub. Date: Sep. 12, 2002

(54) Finger-mountable letter opener

(76) Inventor: Dario De La Cruz, Bell Gardens, CA (US)

Correspondence Address: DARIO DE LA CRUZ, 6853 HANNON ST., BELL GARDENS, CA, 90201, US

(21) Appl. No.: 09/750,767

(22) Filed: Jan. 2, 2001

(51) Int. Cl. B26B 11/00

(52) U.S. Cl. 30/294

(57) ABSTRACT

An improved letter opener having in combination a two-section flat body where the upper flat body (18) terminates in a pointed end (20) and rounded corner (16) on the opposite end, an aperture (22) divides the flat body into upper flat body (18) and lower flat body (24) and leads to a cutting blade (13) which is encased diagonally at one end of the upper flat body (18) and a neck (14), the lower flat body (24) can have gadgets such as a digital clock (42) or can be of different shapes such as funnel (52) and can have perforations of different shapes at one of its ends below the pointed end like a star (50) or ring (58) or it can be blank (24). A semi-cylindrical body (30) of predetermined inside diameter that accommodates a human finger which extends through a hole (28), and to which the flat body is mounted perpendicularly along its upper surface; an inclined surface (12) contiguous to the upper surface of the cylindrical body and extending its fall length maybe formed on both sides to provide extra support for the flat body. In addition, a reducing adaptor (FIGS. 3A to 3B) that reduces the diameter of the hole (28) having two flat surfaces opposite to each other and a post (38) formed on the bottom surface thereof, with which attaches to a socket (34), which is formed in the lower internal wall (32) of the semi-cylindrical body (30), a plurality or a single perforation of different shapes may also be formed in the cylinder wall (10) of the same semi cylindrical body.

### CROSS-REFERENCE TO RELATED APPLICATIONS

Not applicable.

### BACKGROUND

1. Field of Invention

This invention relates to letter openers, in particular those used manually to open paper envelopes of the kind used for correspondence.

2. Description of Prior Art

Since the introduction of the letter opener, manufacturers soon started producing them in different types and shapes, some of them featured unique design like the at symbol (@) shaped letter opener U.S. Pat. No. 405,339 to Marnix Kleefman (1997), and the California State shaped letter opener U.S. Pat. No. 396,791 to Thomas Gray and Robert Gray (1997), others had more practical design like the combination ruler-letter opener U.S. Pat. No. 329,585 to Henry Sawatsky and David P. Sawatsky (1990); but the letter openers described above and all flat shaped letter openers share one problem in that after one has opened several pieces of mail it often happens that those letter openers many times end up lost in the clutter, this is due in part to their flat shape and because the user must release the letter opener in order to reach inside the envelope.

In the latest effort to improve practicality inventors created a battery powered mechanical letter opener U.S. Pat. No. 341,535 to Akira Takashima (1991), however, this letter opener is expensive to manufacture and expensive to operate since this devise is not equiped with dual power mode or alternate current/direct current mode, so when a person gets an average of three to five pieces of mail per day the batteries are drained to the point to affect the performance of this devise in about seven days, thus if the user does not have an extra set of fresh batteries handy this devise becomes ineffective. Moreover, the amount of manipulation required to open paper envelopes is increased relatively since the user must first shake the envelope as in a way to make the contents inside clear the cutting blades to avoid being damaged.

### SUMMARY

In accordance with the present invention a finger-mountable letter opener comprises in combination, a semi-cylindrical body having sufficient inside diameter to receive a person's finger, a two-section flat body encasing a cutting blade and mounted perpendicularly along the upper surface of the semi-cylindrical body, and a reducing adaptor that reduces the inside diameter of the hole.

### OBJECTS AND ADVANTAGES

Accordingly, besides the objects and advantages of the cutting instrument described in my Above patent, several objects and advantages of the present invention are:

(a) to provide a cutting instrument that reduces the amount of time and effort to open paper envelopes;

(b) to provide a cutting instrument that is light and comfortable to wear in a human finger;

(c) to provide a cutting instrument that will not be lost in the clutter like it normally happens with flat shaped letter openers;

(d) to provide a cutting instrument that can be adjusted to fit human fingers of different thickness when used with the reducing adaptor;

(e) to provide a cutting instrument that despite its design can be produced in the same colors, or combination of colors and plastic materials or combination of plastic materials similar to those in present use, without requiring the manufacturer to use extra amount of materials;

(f) to provide a cutting instrument that permits the user to use his/her hand to perform other activities while wearing the instrument.

### DRAWING FIGURES

In the drawing figures, closely related figures have the same number but different alphabetic suffixes.

FIG. 1A shows a side view of a letter opener with a blank lower flat body and multiple perforations in the cylinder wall, the opposite side being a mirror image.

FIG. 1B is a front view of a letter opener without a reducing adaptor showing an inclined surface on both sides and a hole.

FIG. 1C is a bottom view thereof showing a cylindrical body and part of the perforations.

FIG. 1D is a front perspective view of the same letter opener and a top perspective view of a reducing adaptor showing mode of assembly.

FIG. 1E is a front view of a letter opener and a reducing adaptor assembled together.

FIG. 2 is an enlarged view in detail of the portion indicated by the section lines 2 in FIG. 1D.

FIG. 3A is a bottom view of a reducing adaptor showing a post and a notch.

FIG. 3B is a front view thereof.

FIG. 3C is a top perspective view of the same reducing adaptor showing a secondary socket and the notch.

FIG. 4A shows a letter opener with a built in digital clock, time setting buttons and a perforation in the cylinder wall in the shape of a trapezoid.

FIG. 4B is the opposite side showing a button type battery compartment with a lid closed.

FIG. 4C is a front view thereof.

FIG. 4D is a bottom view of the same letter opener partially showing the perforations.

FIG. 5A is a side view of a letter opener showing a lower flat body shaped like a funnel comprising a hole in the shape of a star at one of its ends and a solid star on the opposite end simulating a comet, it also shows a perforation in the shape of a star in the cylinder wall, the opposite side being a mirror image.

FIG. 5B is a bottom view of the same letter opener partially showing the perforations.

FIG. 6A is a side view of a letter opener showing lack of inclined surfaces and the flat body. mounted directly onto the cylinder body, it also shows a lower flat body shaped like a funnel and multiple perforations in the cylinder wall shaped like circles.

FIG. 6B is a bottom view of the same letter opener partially showing the perforations.

FIG. 6C is a front view thereof.

FIG. 7A and 7B shows mode of operation.

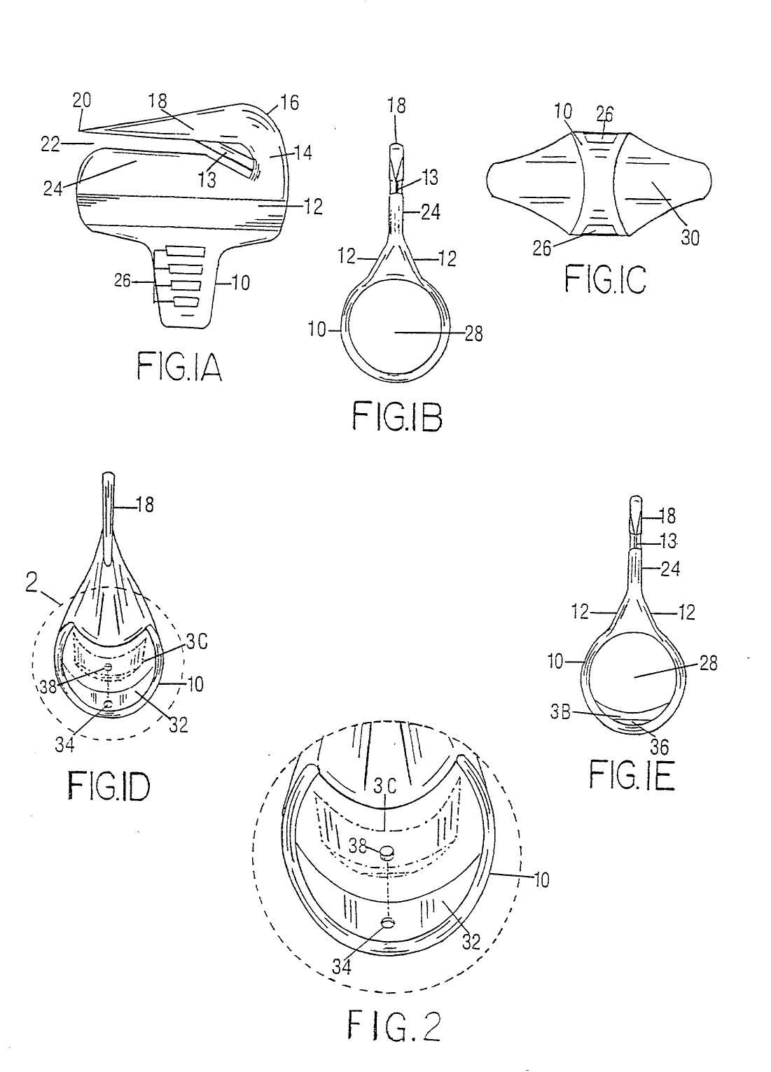

REFERENCE NUMERALS IN DRAWINGS

| | | |
|---|---|---|
| 10 Cylinder wall | 12 Inclined surface | 13 Blade |
| 14 Neck | 16 Corner | 18 Upper flat body |
| 20 Pointed end | 22 Aperture | 24 Lower flat body |
| 26 Horizontal perforations | 28 Hole | 30 Semi-cylindrical body |
| 32 Interior cylinder wall | 34 Main socket | 36 Notch |
| 38 Post | 40 Secondary socket | 42 Digital clock |
| 44 Time setting buttons | 46 Trapezoid perforations | 48 Battery compartment cover |
| 50 Star A perforation | 52 Funnel shaped body | 54 Solid star |
| 56 Star B perforation | 58 Ring | 60 Solid circle |
| 62 Circular perforations | | |

### DESCRIPTION

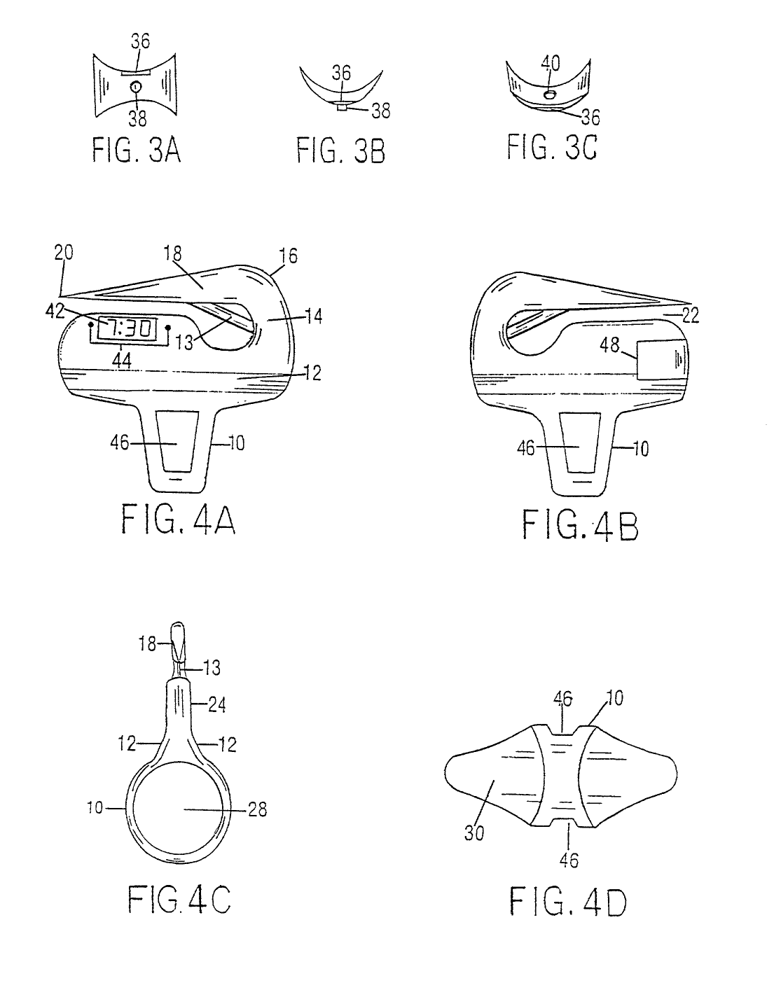

FIGS. 1A to 1E and FIGS. 3A to 3C—Prefered Embodiment

A preferred embodiment of the cutting instrument of the present invention is illustrated in FIG. 1A (side view), FIG. 1B (front view), FIG. 1C (bottom view), FIG. 1D (front perspective view) and FIG. 1E (front view of a letter opener with adaptor. The cutting instrument has a firm structure that except for a metal cutting blade consist of hard plastic such as polyvinyl chloride (pvc), however, the material used for manufacturing can consist of any other solid material such as wood, aluminum, etc. The structure comprises a semi-cylindrical body 30 (FIG. 1C), a two-section flat body 18 and 24 (FIG. 1A) with a cutting blade 13 encased diagonally, a contiguous inclined surface 12 (FIGS. 1A and 1B) on both sides of the cylindrical body and a reducing adaptor (FIGS. 3A to 3C),

In the preferred embodiment the reducing adaptor (FIGS. 3a to 3C) which is made of the same material as the main structure will reduce the inside diameter of a hole 28 (FIG. 1B) when assembled as illustrated in FIGS. 1D and 1E, in this way it will adjust to fit fat or skinny fingers. The mode of attachment of the adaptor 3A to the main structure is by a post 38 located in the center of the bottom surface of the adaptor (FIGS. 3A and 3B), which serves as a male coupler that when aligned to a socket 34 (FIG. 1D) located at the lower internal cylinder wall 32 will then slide in place by slightly pressing both elements together between one's thumb and index finger; a notch 36 (FIG. 3B) of about 1 mm deep is formed at one edge of the bottom surface of the adaptor as to provide space between it and the lower internal wall 32 so that the user can introduce his or her thumbnail for easy removal; a secondary socket 40 (FIG. 3C) located at the center of the top surface of the same adaptor will permit the addition of an extra adaptor if more reduction of the diameter of the hole 28 is desired.

An upper flat body 18 has a rounded corner 16 on one end and on the opposite terminates in a pointed end 20, right below the pointed end 20 an aperture 22 leads to the blade 13 which is encased diagonally in the upper flat body 18 and a neck 14, a lower flat body 24 has a blank surface that can be used for graphics for advertising; both flat and cylindrical bodies are intersected by an inclined surface 12 on both sides (FIGS. 1A and 1B) which serves as extra support and strength and it also allows for more space for graphics. The cylinder wall 10 has a plurality of perforations 26 (FIGS. 1A and 1C) that serve as vents but more important is that they reduce the amount of material needed for manufacturing. The thickness of the upper flat body is about 3.5 mm on the corner end to 0.8 mm on the pointed end, the lower flat body is about 3.0 mm thick and the cylinder wall is about 2.0 mm thick; the overall dimensions of the structure is roughly 5,2 cm long by 5.3 cm from the top of the upper flat body to the base of the outer cylinder wall, the outside and the inside diameter of the hole can vary if manufacturing of a reducing adaptor is not desired.

FIGS. 4A to 4D—Additional Embodiments

Additional embodiment is shown in FIGS. 4A to 4D; in this case a digital clock is built in in the lower flat body and it has a single perforation in the shape of a trapezoid on both sides of the cylinder wall FIG. 4A; FIG. 4B is the opposite side showing a button type battery compartment with the lid closed. FIG. 4C shows a lower flat body somewhat thicker to house clock and battery, FIG. 4D is a bottom view partially showing the perforations.

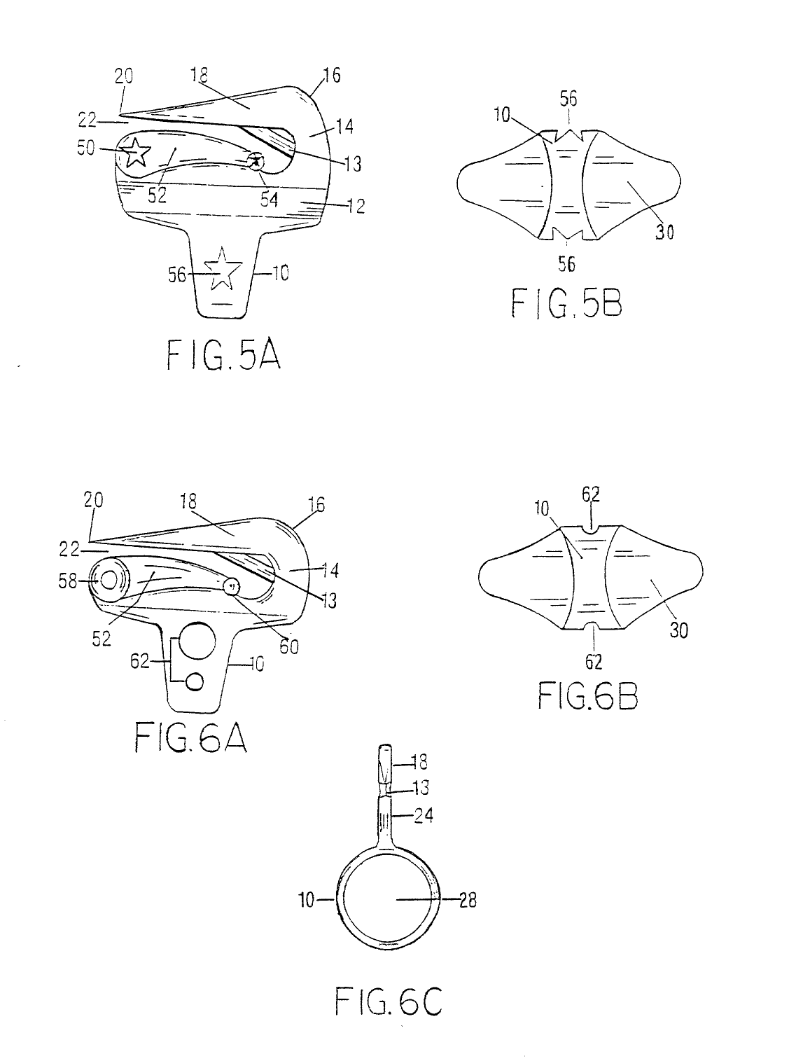

FIGS. 5A to 5B and FIGS. 6A to 6C—Alternative Embodiments

There are various possibilities with regard to the relative disposition of the lower flat body that is blank or features a gadget and the perforations in the cylinder wall which have different geometric shapes as shown in FIG. 5A, which presents a side view of a cutting instrument where the lower flat body is shaped like a funnel and comprises a perforation in the shape of a star below the pointed end and a solid star on the opposite end simulating a comet. The cylinder wall also has a perforation in the shape of a star on both sides; FIG. 5B is a bottom view partially showing the perforations.

FIG. 6A shows a cutting instrument lacking the inclined surfaces, consequently, the flat body is mounted directly onto the cylindrical body, it also shows the lower flat body shaped like a funnel comprising a ring at one of its ends and a solid circle on the opposite end thereof, and the cylinder wall has multiple perforations in the shape of circles on both sides, FIG. 6B is a bottom view partially showing the perforations, FIG. 6C is a front view thereof.

### OPERATION

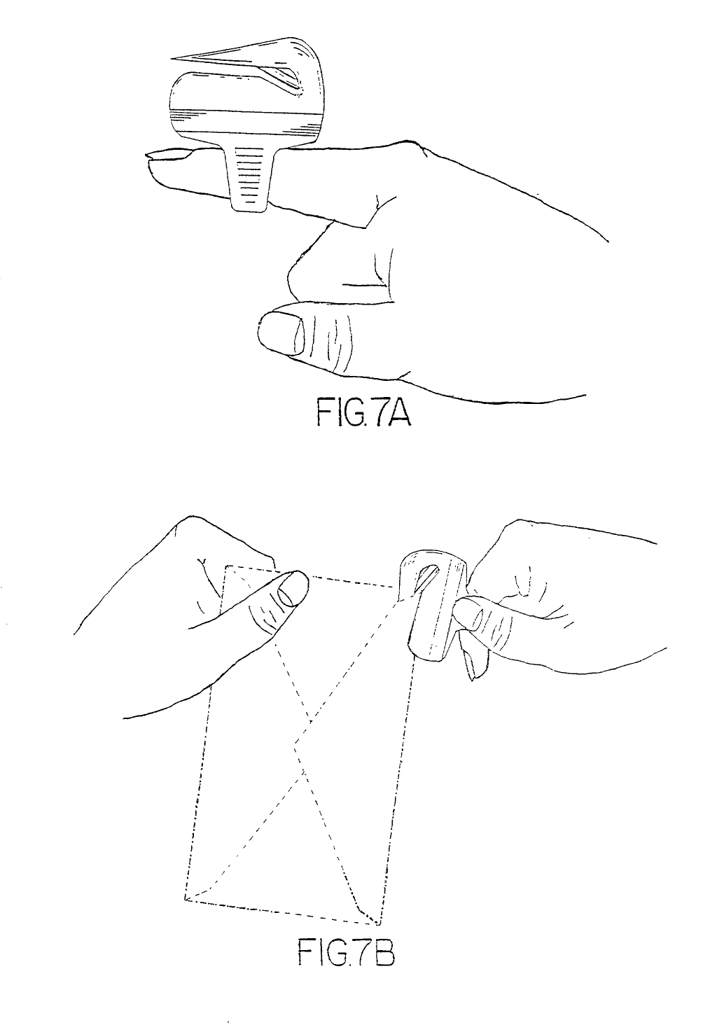

FIGS. 7A and 7B

The manner of using the finger mountable cutting instrument to open paper envelopes is similar to that for non-mechanical letter openers in present use except that the letter opener in this application is designed to be worn in the finger; preferably the index finger and only half way of it or middle phalange to allow for mobility as shown in FIG. 7A, next, one holds a paper envelope from one of its short ends FIG. 7B and inserts the pointed end 20 under the flap of the envelope FIG. 7B and continues the process with a downward motion of the hand bearing the cutting instrument, the user then can reach for the contents inside the envelope while the instrument is still in one's finger

CONCLUSIONS, RAMIFICATIONS, AND SCOPE

Accordingly, the reader will see that the cutting instrument of this invention can be used to open paper envelopes easily and in a more convenient way, one size can be adjusted to fit fingers of different thickness when used with the reducing adaptor; in addition, when compared with a battery powered letter opener one must follow next steps: 1) one picks up an envelope, 2) one must shake the envelope as in a way to make the contents inside clear the cutting blade to avoid being damaged, 3) one then runs the envelope thru the letter opener, 4) one picks up the envelope again to reach for the contents inside; when using my cutting instrument the same process is completed in two steps as described above.

Furthermore, the cutting instrument of this invention has the additional advantages in that

it provides a cutting instrument that has as much surface upon which one can print as conventional flat letter opener;

it provides a cutting instrument that outperforms a mechanical letter opener at a fraction of the cost of such;

it provides a cutting instrument that significantly reduces the amount of manipulation required to open paper envelopes;

it provides a cutting instrument that can be used to cut other materials such as strapping tape, duct tape, wall paper, cellophane etc.;

it allows the user to perform other activities like writing, typing, or use a computer while the cutting instrument is still on one's finger.

Although the description above contains many specificities, these should not be construed as limiting the scope of the invention but as merely providing illustrations of some of the presently preferred embodiments of this invention. For example, the rounded corner of the upper flat body can have other shapes such as squared corner, scalloped, etc., the post and the socket can have other shapes; the diameter of the hole can be manufactured in different sizes if the manufacturer considers unnecessary the inclusion of a reducing adaptor; the perforations in the lower flat body and the cylinder wall can have other shapes like heart, cloverleaf, diamond, triangle, etc.; the same perforations can be combined in one structure like lower flat body with a star and a trapezoid in the cylinder wall, and instead of being machined or cast they can be embossed or they can have none of the above.

Thus the scope of the invention should be determined by the appended claims and their legal equivalents, rather than by the examples given.

I claim:

1. A finger-mountable cutting instrument, comprising, in combination:
a) an elongated semi-cylindrical body of solid material having a longitudinal axis, contoured and having an inside diameter of sufficient size to receive a human finger and through which the user's finger extends,
b) an elongated flat body encasing means for cutting paper and other soft materials is mounted perpendicularly along the upper surface and extends the full length of said semi-cylindrical body, an aperture below a pointed end leads to said cutting means and divides said flat body into upper and lower flat bodies, and terminates at a neck, which joins said upper and lower flat bodies,
c) means for reducing said inside diameter of said semi-cylindrical body that allows users with fingers of different thickness to adjust accordingly, whereby the user can open paper envelopes of the kind used for correspondence and cut thru other materials with said cutting instrument conveniently mounted in said finger.

2. The cutting instrument of claim 1 wherein a rounded opening is formed in the center of the lower internal wall of said semi-cylindrical body and to which said means for reducing said inside diameter attaches to.

3. The cutting instrument of claim 1 wherein said means for reducing said inside diameter is crescent-shaped, has two flat surfaces opposite to each other and is made of the same said solid material as the main structure.

4. The cutting instrument of claim 1 wherein said means for reducing said inside diameter has a post formed in the center of one of said flat surfaces and with which attaches to said socket.

5. The cutting instrument of claim 1 wherein said means for reducing said inside diameter has a notch formed at one edge of the bottom of one of said flat surfaces thereof.

6. The cutting instrument of claim 1 wherein a plurality of perforations are formed horizontally in the cylinder wall on both sides of said semi-cylindrical body.

7. The cutting instrument of claim one wherein an inclined surface supports said flat body and is formed on both sides, and extends the full length of said semi-cylindrical body and flat body thereof.

8. The cutting instrument of claim 1 wherein said cutting means is encased diagonally at one end of said upper flat body and said neck.

9. The cutting instrument of claim 1 wherein said cutting means is a sharp metal blade.

10. The cutting instrument of claim 1 wherein said semi-cylindrical body and said flat body form one structure.

11. The cutting instrument of claim 1 wherein said semi-cylindrical body and said flat body are elongated, and has a digital clock built in said lower flat body.

12. The cutting instrument of claim 11 wherein a perforation in the shape of a trapezoid is formed in said wall on both sides of said semi-cylindrical body.

13. The cutting instrument of claim 11 wherein a battery compartment is formed on the opposite side of said lower flat body.

14. The cutting instrument of claim 1 wherein said semi-cylindrical body and said flat body are elongated and said lower flat body is shaped like a funnel and has a perforation in the shape of a star at one of its ends thereof, and a star is embossed on the opposite end.

15. The cutting instrument of claim 14 wherein a perforation in the shape of a star is formed in said wall on both sides of said semi-cylindrical body.

16. The cutting instrument of claim 1 wherein said semi-cylindrical body and said flat body are elongated and lacks said inclined surfaces.

17. The cutting instrument of claim 16 wherein said lower flat body is shaped like a funnel and has a ring formed at one of its ends thereof, and a circle on the opposite end.

18. The cutting instrument of claim 16 wherein a plurality of perforations in the shape of circles are formed in said wall on both sides of said semi-cylindrical body.
